(19) United States
(12) Patent Application Publication
(10) Pub. No.: US 2003/0114133 A1
(43) Pub. Date: Jun. 19, 2003

(54) MP3 player for vehicles

(76) Inventor: Ryan S. Enners, Starksboro, VT (US)

Correspondence Address: HEWLETT-PACKARD COMPANY, Intellectual Property Administration, P.O. Box 272400, Fort Collins, CO, 80527-2400, US

(21) Appl. No.: 10/020,252

(22) Filed: Dec. 14, 2001

(51) Int. Cl. H04B 1/06

(52) U.S. Cl. 455/344; 455/150.1

(57) ABSTRACT

A portable or mobile MP3 music player that may be used in a vehicle and as a portable personal music playing device that is carried by a user. An exemplary player comprises a detachable faceplate or faceplate controller of a vehicle audio system. The player includes memory devices that store downloaded music files. A communication interface interfaces between an external computer and the memory devices and is used to download music files to the player. A microprocessor is coupled to the memory devices and the communication interface and controls operation of the player. An audio interface permits music files to be played though a vehicle audio system. A headphone interface permits the music files to be played through external headphones. A receiver is coupled to an antenna that permits reception of radio broadcasts which may be listened to through the headphones. The faceplate may be used as a handheld device with headphones connected to it, or may be attached to the vehicle stereo system so that music may be played therethrough.

### BACKGROUND

The present invention relates generally to music-related systems, and more specifically, to an MP3 music player that is portable and which may be used in vehicles, and the like.

Current MP3 mobile units only act as a Walkman™-like device and cannot be used to play music through vehicle speaker systems. There are no currently-available vehicle MP3 units that are mobile and are able to be used with vehicle speakers. All currently-available vehicle MP3 units require some sort of media (tape, CD). It would be desirable to provide a means for listening to music from a mobile music player without using external physical media.

A search relating to the present invention was performed in the U.S. Patent and Trademark Office and uncovered the following U.S. patents: U.S. Pat. No. 5,796,164, U.S. Pat. No. 6,061,306, and U.S. Pat. No. 6,167,251.

U.S. Pat. No. 5,796,164 discloses a “vehicle computer system has a housing sized to be mounted in a vehicle dashboard or other appropriate location, a computer mounted within the housing, and an open platform operating system which executes on an open hardware architecture computer. The open platform operating system supports multiple different applications that can be supplied by a vehicle user. For instance, the operating system can support applications pertaining to entertainment, navigation, communications, security, diagnostics, and others. The computer has one or more storage drive (e.g., CD drive, floppy disk drive, cassette player, or hard disk drive) which permits the vehicle user to download programs from a storage medium (e.g., CD, diskette, cassette, or hard disk) to the computer. In the described implementation, the computer has two independent processors. One processor, which runs the operating system, is mounted in a stationary base unit of the housing and the other processor is mounted to a faceplate which is detachable from the base unit. When the faceplate is attached, the first processor provides the primary control over all operating systems (i.e., entertainment, navigation, communications, security, diagnostics, and others) and the faceplate processor is subservient. When the faceplate is detached, it forms a portable RF device with the faceplate processor providing radio and communications capabilities.”

U.S. Pat. No. 5,796,164 discloses with regard to FIG. 1 that “The computer 22 includes at least one storage drive which permits the vehicle user to download programs and data from storage medium. In the illustrated implementation, the computer 22 has a CD ROM drive 38 which reads application-related CDs, as well as musical, video, game, or other types of entertainment CDs. In this manner, the CD ROM drive 38 performs a dual role of storage drive and entertainment player.”

U.S. Pat. No. 6,061,306 discloses a “Portable digital player compatible with a cassette player” that “includes (a) a housing shaped as a cassette and insertable into a cassette deck of a cassette player; (b) a digital audio player in the housing, the digital audio player including a memory and an audio chip for storing and subsequently playing digital audio information through at least one speaker; and (c) an emulator in the housing, the emulator operatively communicating with the digital audio player for emulating the digital audio information as analog audio information readable by a magnetic playing head of the cassette player for playing the digital audio information through the cassette player.”

U.S. Pat. No. 6,061,306 also discloses that “Digital audio player 14 . . . includes . . . a memory 16 and an audio chip 18 which together serve for storing and subsequently playing digital audio information through at least one, preferably two or more, speakers 20. Chip 18 is preferably adapted at encoding and decoding audio data compressed formats, such as, but not limited to, MP3, MP4, AT&T, a2b, Liquid Audio, Real Audio, SDMI and/or any other existing or developable audio data compressed format.”

U.S. Pat. No. 6,167,251 discloses with regard to FIG. 29 that an “External downloadable music source 38n is also shown in FIG. 29. Downloadable music may be available to a keyless portable cellular phone 34, such as accessed through a preferred replaceable airtime cartridge 52. Downloadable music, such as transferred in MPS format, may be played through the system server 30, or may be downloaded to a preferred airtime cartridge having an internal MP3 player, which plays the music signal as it receives the signal, or preferably stores it to internal airtime cartridge memory, such as for later playback.”

U.S. Pat. No. 6,167,251 also discloses that “For example, a user may activate the keyless portable cellular phone 34 for a limited time, to download music 38n, and may store the music internally to a preferred airtime cartridge, allowing the user to play back the music one or more times, such as when the keyless portable cellular phone 34 is not activated (and unconnected to the system server 30), thus avoiding the cost of debited airtime communication units 57 while listening to the stored music.”

It is an objective of the present invention to provide for an improved MP3 music player that is portable and that may be used in vehicles.

### SUMMARY OF THE INVENTION

To accomplish the above and other objectives, the present invention provides for a portable MP3 music player that is portable and which is particularly well suited for use in vehicles, and the like. The present invention provides for a portable or mobile MP3 music player that may be used in a vehicle and as a portable personal music playing device that is carried by a user.

An exemplary portable music player comprises a housing that is a detachable faceplate or detachable faceplate controller of a vehicle audio system. One or more memory devices are disposed in the housing that store downloaded music files. A communication interface is disposed in the housing that interfaces between an external computer and the memory devices and is used to download music files to the portable music player. A microprocessor is disposed in the housing that is coupled to the memory devices and the communication interface for controlling the portable music player.

An audio interface is disposed in the housing that is coupled between the memory devices and the vehicle audio system that permits the music files to be played though the vehicle audio system. A headphone interface is disposed in the housing that permits the music files to be played through external headphones connected thereto. A receiver may be disposed in the housing that is coupled to an antenna that permits reception of radio broadcasts which may be listened to through the headphones.

The present MP3 music player thus comprises a detachable faceplate that contains memory chips that store MP3 music files. The faceplate may be connected to a personal computer to allow download of MP3 music files. The faceplate may be used as a handheld device with headphones connected to it, or may be attached to the vehicle stereo system so that music may be played therethrough. When attached to the vehicle stereo system, the faceplate is coupled to and uses the vehicle speakers and vehicle antenna.

Furthermore, additional memory devices may be disposed in the vehicle audio system that are coupled to the portable music player by way of the communication interface. MP3 music files downloaded to the MP3 music player from the external computer may be transferred to the additional memory devices for long term storage of the music files. The music files stored in the additional memory devices are accessed by way of the microprocessor in the same manner as the memory devices in the portable music player.

The present invention thus provides an entertainment source for mobile people that allows them to listen to music without the need of carrying external media. The portable MP3 player may be used in a vehicle or as a stand-alone portable device.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 illustrates an exemplary MP3 music player in accordance with the principles of the present invention that may be used as part of a vehicle audio system;

FIG. 2 is an enlarged view of the MP3 music player shown in FIG. 1 illustrating additional details thereof; and

FIG. 3 illustrates the exemplary MP3 music player connected to a personal computer to permit downloading of music files thereto.

### DETAILED DESCRIPTION

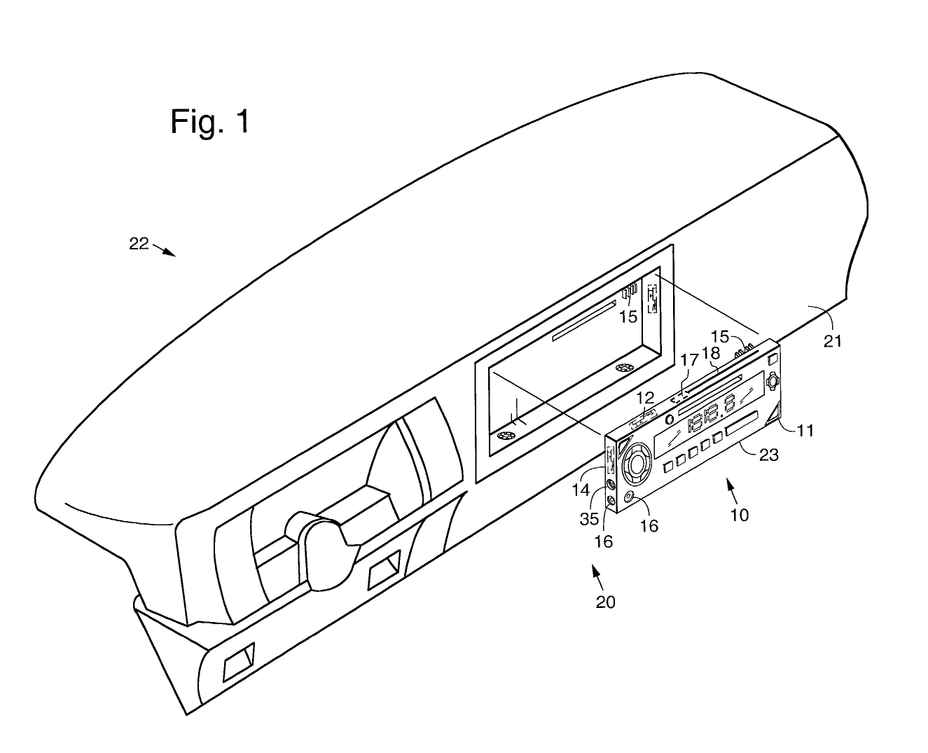

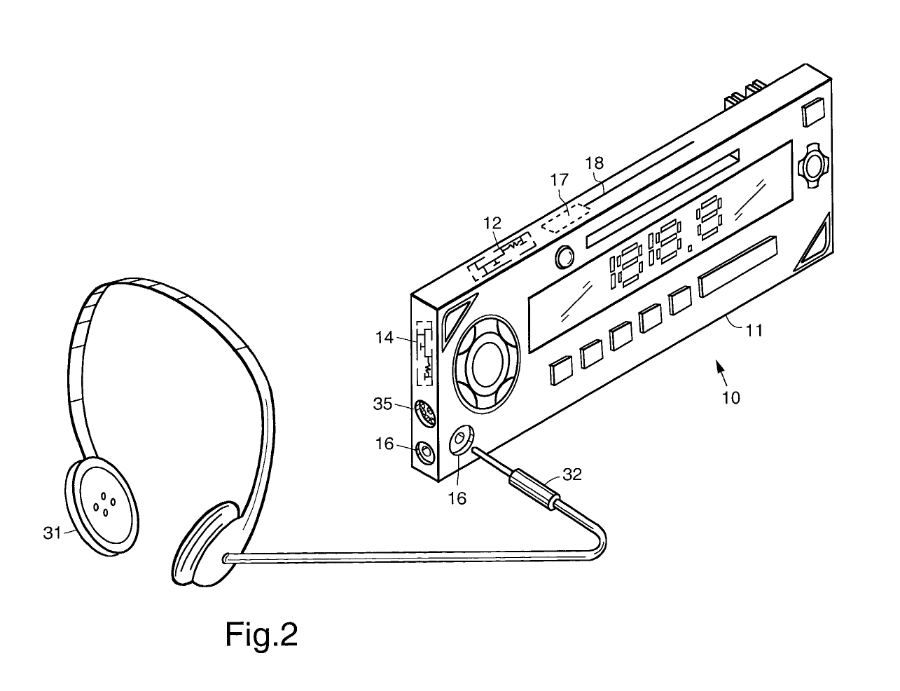

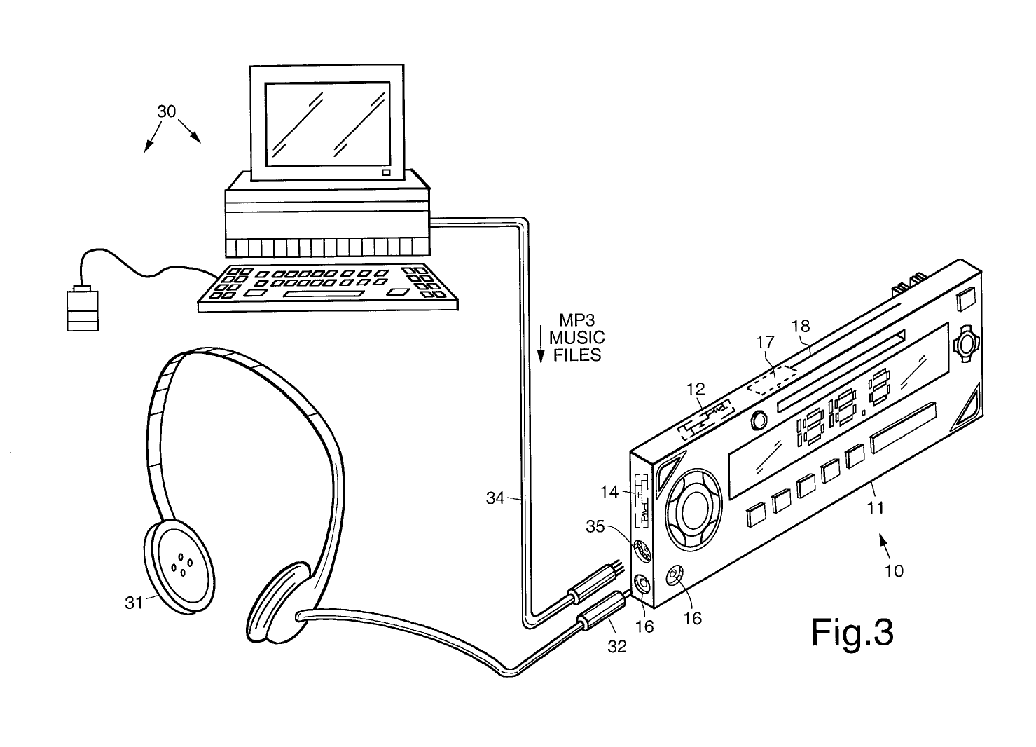

Referring to the drawing figures, FIG. 1 illustrates an exemplary MP3 music player 10 in accordance with the principles of the present invention that may be used as part of a vehicle audio system 20. FIG. 2 is an enlarged view of the MP3 music player 10 illustrating additional details. FIG. 3 illustrates the MP3 music player 10 connected to a personal computer 30 to permit downloading of MP3 music files to the MP3 music player 10.

The vehicle audio system 20 is disposed in a dashboard 21 of a vehicle 22. A preferred embodiment of the MP3 music player 10 comprises a removable or detachable faceplate 23 or a removable or detachfaceplate controller 23 of the vehicle audio system 20.

The exemplary portable music player 10 comprises a housing 11 that is preferably configured as the detachable faceplate controller 11 of the vehicle audio system 20. One or more memory devices 12 are disposed in the housing 11 for storing downloaded music files. A communication interface 13 is coupled to the one or more memory devices 12 for interfacing with the external computer 30 (FIG. 3) that is used to download music files to the portable music player 10.

A microprocessor 14 is disposed in the housing 11 that is coupled to the one or more memory devices 12 and the communication interface 13. The microprocessor 14 is used to control the portable music player 10 and download music files from the external computer 30 to the memory devices 12 by way of the communication interface 13. An audio interface 15 is disposed in the housing 11 that is coupled to the microprocessor 14 and one or more memory devices 12 and to the vehicle audio system 20 that permits the music files to be played by a vehicle audio system 20.

The housing 11 includes a headphone interface 16 that permits the music files to be played through external headphones 31 (FIG. 2) connected thereto. As is shown in FIG. 2, the headphone interface 16 is used to couple the portable music player 10 to external headphones 31 having a headphone jack 32.

As is shown in FIG. 3, the external headphones 31 may be connected to the portable music player 10 by inserting the headphone jack 32 into the headphone interface 16. As is also shown in FIG. 3, the external computer 30 may be connected to the portable music player 10 by coupling a communications cable 34 between a port (not shown) of the external computer 30 and a communications link connector 35 of the communication interface 13.

A receiver 17 may also be disposed in the housing 11 that is coupled to an antenna 18 that permits reception of radio broadcasts, for example. The receiver 17 permits reception of radio broadcasts which may be listened to through the headphones 31.

Additional memory devices 12a may be disposed in the vehicle audio system 20 (such as in a portion of the audio system surrounding the detachable faceplate controller 11 or housing 11). The additional memory devices 12a are coupled to the portable music player 10 by way of the communication interface 13. MP3 music files downloaded to the MP3 music player 10 from the external computer 30 may be transferred to the additional memory devices 12a for long term storage of the music files. The music files stored in the additional memory devices 12a are accessed by way of the microprocessor 14 in the same manner as the memory devices 12 located in the portable music player 10.

The portable MP3 music player 10 thus comprises a detachable faceplate 23, or detachable faceplate controller 23, that contains memory chips 12 that store MP3 music files. The faceplate 23 may be connected to the personal computer 30 to allow MP3 music files to be downloaded to the faceplate 23. As is illustrated in FIG. 2, for example, the faceplate 23 may be used as a handheld device with headphones 31 connected to it by way of the headphone interface 16, or may be attached to the vehicle stereo system 20 by way of the audio interface 15 so that music may be played through the vehicle stereo system 20. The memory 12 and a microprocessor 14 are contained in the faceplate 23 of the music player 11. When attached to the vehicle audio system 20, the faceplate 23 is coupled to and uses the speakers of the vehicle audio system 20.

Thus, a portable MP3 music player that may be used in vehicles has been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A portable music player comprising:
a housing comprising a detachable faceplate of a vehicle audio system;
one or more memory devices disposed in the housing for storing downloaded music files;
a communication interface coupled to the memory devices for interfacing with an external computer that is used to download music files to the portable music player;
a microprocessor disposed in the housing that is coupled to the memory devices and the communication interface for controlling the portable music player; and
an audio interface disposed in the housing that is coupled between the memory devices and the vehicle audio system that permits the music files to be played by the vehicle audio system.

2. The portable music player recited in claim 1 further comprising a headphone interface disposed in the housing that permits the music files to be played through external headphones connected thereto.

3. The portable music player recited in claim 1 further comprising a receiver disposed in the housing that is coupled to an antenna to permits reception of radio broadcasts

4. A portable music player comprising:
a housing comprising a detachable faceplate of a vehicle audio system;
one or more memory devices disposed in the housing for storing downloaded music files;
a communication interface coupled to the memory devices for interfacing with an external computer that is used to download music files to the portable music player;
a microprocessor disposed in the housing that is coupled to the memory devices and the communication interface for controlling the portable music player;
an audio interface disposed in the housing that is coupled between the memory devices and the vehicle audio system that permits the music files to be played by the vehicle audio system; and
a headphone interface disposed in the housing that permits the music files to be played through external headphones connected thereto.

5. The portable music player recited in claim 4 further comprising a receiver disposed in the housing that is coupled to an antenna to permits reception of radio broadcasts
